(19) United States
(12) Patent Application Publication
(10) Pub. No.: US 2024/0112581 A1
(43) Pub. Date: Apr. 4, 2024

(54) TRAFFIC SAFETY SUPPORT SYSTEM AND STORAGE MEDIUM

(71) Applicants: HONDA MOTOR CO., LTD., Tokyo (JP); Honda Research Institute Europe GmbH, Offenbach/Main (DE)

(72) Inventors: Ryohei HIRANO, Saitama (JP); Tim PUPHAL, Offenbach/Main (DE); Akihito KIMATA, Saitama (JP); Yuji TAKAGI, Saitama (JP)

(21) Appl. No.: 17/936,853

(22) Filed: Sep. 30, 2022

(51) Int. Cl. G08G 1/16; G08G 1/017

(52) U.S. Cl. CPC G08G 1/166; G08G 1/017

(57) ABSTRACT

A coordination support device includes a target traffic area recognizer configured to recognize traffic participants, a predictor configured to predict futures of a plurality of the traffic participants, and a coordination support information notifier configured to notify notification targets. The predictor includes a group classifier configured to divide the plurality of traffic participants into a plurality of moving groups G1 to G9 and acquire moving group information, a first predictor configured to predict whether or not a collision will occur among the moving groups G1 to G9 on the basis of the moving group information and specifies collision sites in the moving groups that are predicted to collide, and a second predictor configured to determine two or more specific traffic participants among the plurality of traffic participants on the basis of the collision sites and predict whether or not a collision will occur among the specific traffic participants.

### BACKGROUND OF THE INVENTION

### Field of the Invention

The present invention relates to a traffic safety support system and a storage medium. More specifically, the present invention relates to a traffic safety support system that supports safe movement of traffic participants as persons or moving bodies, and a storage medium.

### Related Art

In public traffic, various traffic participants such as moving bodies including four-wheeled vehicles, motorcycles, bicycles, and the like, and pedestrians move at different speeds on the basis of individual intentions. As a technique for improving safety, convenience, and the like, of traffic participants in such public traffic, for example, Patent Document 1 discloses a traveling safety device that supports safe driving by a driver of a vehicle.

The traveling safety device disclosed in Patent Document 1 detects objects around a vehicle with an on-board sensor mounted on the own vehicle, determines a moving body that comes close to a traveling path of the own vehicle among the detected objects, and in a case where it is determined that there is a possibility that the determined moving body may collide with the own vehicle, notifies a driver of the own vehicle. In particular, in this invention, in a case where a plurality of moving bodies exists, these moving bodies are grouped, and the driver is notified once for each group. By this means, in a case where there is a plurality of moving bodies that come close to the own vehicle, notification is performed for each group, so that it is possible to reduce cumbersomeness to be felt by the driver.
Patent Document 1: Japanese Unexamined Patent Application, Publication No. 2011-76527

### SUMMARY OF THE INVENTION

By the way, in the invention disclosed in Patent Document 1, a level of danger is predicted on the basis of information on a surrounding environment acquired by an on-board sensor such as a camera and a radar mounted on the own vehicle, and thus, a potential risk existing outside a detection range of the on-board sensor cannot be grasped. Thus, in order to enable appropriate support also with respect to such a potential risk, it is, for example, conceivable to aggregate information regarding traffic participants existing in a predetermined target traffic area to a server connected to each traffic participant so as to be able to perform communication and comprehensively grasp flow of the traffic participants in this target traffic area at the server.

However, if information on an enormous number of traffic participants existing in the target traffic area is aggregated to the server in this manner, processing load at the server correspondingly increases, which may inhibit provision of appropriate support to each traffic participant in the target traffic area in real time.

The present invention is directed to providing a traffic safety support system capable of predicting a risk that may occur among some of a number of traffic participants existing in a target traffic area with low processing load, and a storage medium.

(1) A traffic safety support system according to the present invention includes a recognizer configured to recognize traffic participants as persons or moving bodies in a target traffic area and acquire recognition information regarding each traffic participant, a predictor configured to predict futures of a plurality of the traffic participants recognized by the recognizer on the basis of the recognition information, and a notifier configured to determine notification targets among the plurality of traffic participants on the basis of a prediction result by the predictor and notify the notification targets, in which the recognizer acquires information including a position and a moving vector of each traffic participant as the recognition information, and the predictor includes a classifier configured to divide the plurality of traffic participants recognized by the recognizer into a plurality of moving groups on the basis of the recognition information and acquire moving group information including a position, a shape and a moving vector of each moving group, a first predictor configured to predict whether or not a collision will occur among the moving groups on the basis of the moving group information and specify collision sites in the moving groups that are predicted to collide, and a second predictor configured to, in a case where it is predicted by the first predictor that a collision will occur, determine two or more specific traffic participants among the plurality of traffic participants on the basis of the collision sites and predict whether or not a collision will occur among the specific traffic participants.

(2) In this case, the traffic safety support system preferably further includes a driving subject information acquirer configured to acquire state information correlated with driving capabilities of driving subjects of the moving bodies recognized as the traffic participants by the recognizer, and the second predictor preferably predicts whether or not a collision will occur among the specific traffic participants on the basis of the recognition information and the state information of the specific traffic participants.

(3) In this case, the predictor preferably further includes a third predictor configured to, in a case where at least one of the two or more specific traffic participants that are predicted to collide by the second predictor takes collision avoidance action, predict a risk posed to traffic participants existing around the specific traffic participants.

(4) In this case, the notifier preferably makes a first notification to the specific traffic participants as first notification targets and makes a second notification with lower notification strength than notification strength of the first notification to traffic participants other than the specific traffic participants among the traffic participants belonging to the moving groups that are predicted to collide by the first predictor, as second notification targets.

(5) In this case, the notifier preferably makes the notification strength of the second notification lower as a distance between the specific traffic participants and the second notification targets becomes longer.

(6) In this case, the notifier preferably makes a first notification to the specific traffic participants as first notification targets, makes a second notification with lower notification strength than notification strength of the first notification to traffic participants other than the specific traffic participants among the traffic participants belonging to the moving groups that are predicted to collide by the first predictor, as second notification targets and makes a third notification with lower notification strength than the notification strength of the first notification to traffic participants to which it is predicted by the third predictor that a risk is to be posed, as third notification targets.

(1) In a traffic safety support system, a recognizer recognizes traffic participants in a target traffic area and acquires recognition information of the traffic participants, a predictor predicts futures of the traffic participants on the basis of the recognition information, and a notifier determines notification targets from a plurality of the traffic participants on the basis of a prediction result by the predictor and notifies the notification targets. In particular, in the present invention, a classifier of the predictor divides a plurality of the traffic participants that are recognized into a plurality of moving groups, acquires moving group information including positions, shapes and moving vectors of the moving groups, a first predictor of the predictor predicts whether or not a collision will occur among the moving groups on the basis of the moving group information and specifies collision sites in the moving groups that are predicted to collide, and in a case where it is predicted by the first predictor that a collision will occur, a second predictor of the predictor determines two or more specific traffic participants from a plurality of the traffic participants on the basis of the collision sites and predicts whether or not a collision will occur among the specific traffic participants. Thus, according to the present invention, after specific traffic participants for which prediction should be performed are more specifically narrowed down from a plurality of traffic participants through processing in the first predictor, whether or not a collision will occur among the specific traffic participants can be predicted through processing in the second predictor, so that it is possible to predict a risk of a collision among some of a number of traffic participants existing in the target traffic area with low processing load, which leads to support of safe traffic in the target traffic area.

(2) In the traffic safety support system, a driving subject information acquirer acquires state information correlated with driving capabilities of driving subjects of the moving bodies, and the second predictor predicts whether or not a collision will occur among the specific traffic participants on the basis of the recognition information and the state information for the specific traffic participants. In other words, in the present invention, by predicting whether or not a collision will occur among the specific traffic participants while the state information of the specific traffic participants is taken into account for the specific traffic participants narrowed down from a plurality of traffic participants through processing at the first predictor, it is possible to predict whether or not a collision will occur among the specific traffic participants with low processing load with high accuracy, which leads to support of safe traffic in the target traffic area.

(3) In the traffic safety support system, in a case where at least one of the two or more specific traffic participants that are predicted to collide by the second predictor takes collision avoidance action, a third predictor of the predictor predicts a risk posed to traffic participants existing around the specific traffic participants. Thus, according to the present invention, futures of the traffic participants can be predicted while collision avoidance action to be taken by the specific traffic participants is taken into account, so that it is possible to support safe traffic in the target traffic area.

(4) In the traffic safety support system, a notifier makes a first notification to the specific traffic participants and makes a second notification with lower notification strength than notification strength of the first notification to traffic participants other than the specific traffic participants among the traffic participants belonging to the moving groups that are predicted to collide by the first predictor. Thus, according to the present invention, it is possible to cause the specific traffic participants to take appropriate collision avoidance action via the first notification and causes the traffic participants other than the specific traffic participants to take action for avoiding a linked risk that may occur due to a collision among the specific traffic participants. Further, according to the present invention, by making the notification strength of the second notification lower than the notification strength of the first notification, it is possible to reduce cumbersomeness to be felt by the traffic participants other than the specific traffic participants.

(5) in the traffic safety support system, the notifier makes the notification strength of the second notification lower as a distance between the specific traffic participants and the second notification targets becomes longer. This can reduce cumbersomeness to be felt by the traffic participants other than the specific traffic participants.

(6) In the traffic safety support system, the notifier makes a first notification to the specific traffic participants, makes a second notification with lower notification strength than notification strength of the first notification to traffic participants other than the specific traffic participants among the traffic participants belonging to the moving groups that are predicted to collide by the first predictor, and makes a third notification with lower notification strength than the notification strength of the first notification to traffic participants to which it is predicted by the third predictor that a risk is to be posed. Thus, according to the present invention, it is possible to cause the specific traffic participants to take appropriate collision avoidance action via the first notification and causes the traffic participants other than the specific traffic participants and the traffic participants to which it is predicted by the third predictor that a risk is to be posed to take action for avoiding a linked risk that may occur due to a collision among the specific traffic participants. Further, according to the present invention, by making the notification strength of the second notification and the third notification lower than the notification strength of the first notification, it is possible to reduce cumbersomeness to be felt by the traffic participants other than the specific traffic participants.

### BRIEF DESCRIPTION OF THE DRAWINGS

FIG. 1 is a view illustrating a configuration of a traffic safety support system according to one embodiment of the present invention and part of a target traffic area to be supported by the traffic safety support system;

FIG. 2 is a block diagram illustrating a configuration of a coordination support device and a plurality of area terminals connected to the coordination support device so as to be able to perform communication;

FIG. 3A is a block diagram illustrating a configuration of a notification device mounted on a four-wheeled vehicle;

FIG. 3B is a block diagram illustrating a configuration of a notification device mounted on a motorcycle;

FIG. 3C is a block diagram illustrating a configuration of a notification device mounted on a mobile information processing terminal possessed by a pedestrian;

FIG. 4 is a functional block diagram illustrating a specific configuration of a predictor;

FIG. 5 is a view illustrating an example of a monitoring area;

FIG. 6 is a view illustrating an example of a prediction result of a first predictor; and

FIG. 7 is a flowchart illustrating specific procedure of traffic safety support processing.

### DETAILED DESCRIPTION OF THE INVENTION

A traffic safety support system according to one embodiment of the present invention will be described below with reference to the drawings.

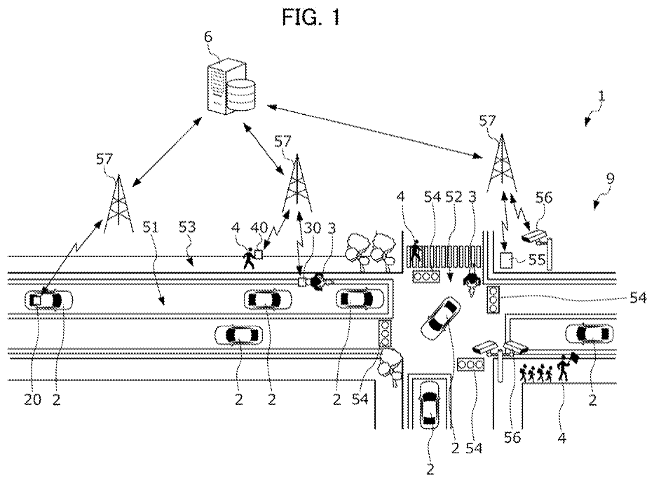

FIG. 1 is a view schematically illustrating a configuration of a traffic safety support system 1 according to the present embodiment and part of a target traffic area 9 in which traffic participants to be supported by the traffic safety support system 1 exist.

The traffic safety support system 1 supports safe and smooth traffic of traffic participants in the target traffic area 9 by recognizing pedestrians 4 that are persons moving in the target traffic area 9 and four-wheeled vehicles 2, motorcycles 3, and the like, that are moving bodies as individual traffic participants, notifying each traffic participant of support information generated through the recognition to encourage communication (specifically, for example, reciprocal recognition between the traffic participants) between the traffic participants that move on the basis of intentions of the traffic participants and recognition of a surrounding traffic environment.

FIG. 1 illustrates a case where an area around an intersection 52 in an urban area, including a road 51, the intersection 52, a pavement 53 and traffic lights 54 as traffic infrastructure equipment is set as the target traffic area 9. FIG. 1 illustrates a case where a total of seven four-wheeled vehicles 2 and a total of two motorcycles 3 move on the road 51 and at the intersection 52 and a total of three sets of pedestrians 4 move on the pavement 53 and at the intersection 52. Further, FIG. 1 illustrates a case where a total of three infrastructure cameras 56 are provided.

The traffic safety support system 1 includes on-board devices 20 (including on-board devices mounted on the four-wheeled vehicles 2 and mobile information processing terminals possessed or worn by drivers who drive the four-wheeled vehicles 2) that move along with individual four-wheeled vehicles 2, on-board devices 30 (including on-board devices mounted on the motorcycles 3 and mobile information processing terminals possessed or worn by drivers who drive the motorcycles 3) that move along with individual motorcycles 3, mobile information processing terminals 40 possessed or worn by the respective pedestrians 4, a plurality of the infrastructure cameras 56 provided in the target traffic area 9, a traffic light control device 55 that controls the traffic lights 54, and a coordination support device 6 connected to a plurality of terminals (hereinafter, also simply referred to as “area terminals”) such as these on-board devices 20 and 30, the mobile information processing terminals 40, the infrastructure cameras 56 and the traffic light control device 55 existing in the target traffic area 9 so as to be able to perform communication.

The coordination support device 6 includes one or more computers connected to the above-described plurality of area terminals via a base station 57 so as to be able to perform communication. More specifically, the coordination support device 6 includes a server connected to the plurality of area terminals via the base station 57, a network core and the Internet, an edge server connected to the plurality of area terminals via the base station 57 and an MEC (multi-access edge computing) core, and the like.

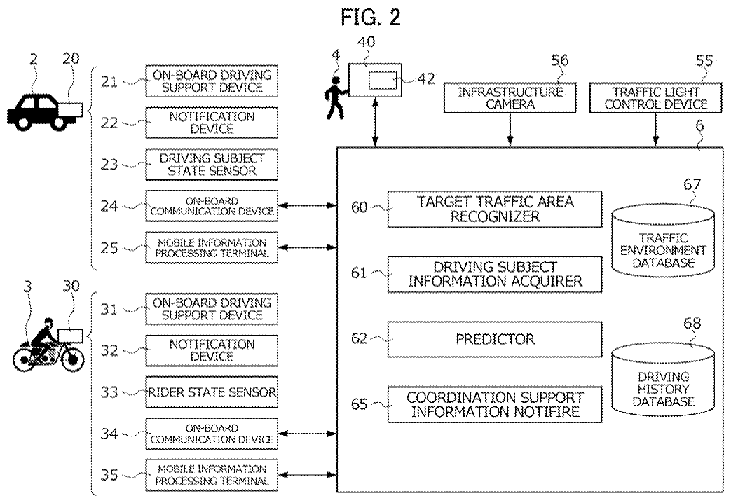

FIG. 2 is a block diagram illustrating a configuration of the coordination support device 6 and a plurality of area terminals connected to the coordination support device 6 so as to be able to perform communication.

The on-board devices 20 mounted on the four-wheeled vehicles 2 in the target traffic area 9 include, for example, an on-board driving support device 21 that supports driving by a driver, a notification device 22 that notifies the driver of various kinds of information, a driving subject state sensor 23 that detects a state of the driver who is driving, an on-board communication device 24 that performs wireless communication between the own vehicle and the coordination support device 6 and other vehicles near the own vehicle, a mobile information processing terminal 25 possessed or worn by the driver, and the like.

The on-board driving support device 21 includes an external sensor, an own vehicle state sensor, a navigation device, a driving support ECU, and the like. The external sensor includes an exterior camera that captures an image around the own vehicle, a plurality of on-board external sensors mounted on the own vehicle, such as a radar and a LIDAR (light detection and ranging) that detects a target outside the vehicle using an electromagnetic wave, and an outside recognition device that acquires information regarding a state around the own vehicle by performing sensor fusion processing on detection results by these on-board external sensors. The own vehicle state sensor includes a sensor that acquires information regarding a traveling state of the own vehicle, such as a vehicle speed sensor, an acceleration sensor, a steering angle sensor, a yaw rate sensor, a position sensor and an orientation sensor. The navigation device includes, for example, a GNSS receiver that specifies a current position of the own vehicle on the basis of a signal received from a GNSS (global navigation satellite system) satellite, a storage device that stores map information, and the like.

The driving support ECU executes driving support control such as lane departure prevention control, lane change control, preceding vehicle following control, erroneous start prevention control, collision mitigation brake control and collision avoidance control on the basis of the information acquired by the external sensor, the own vehicle state sensor, the navigation device, and the like. Further, the driving support ECU generates driving support information for supporting safe driving by the driver on the basis of the information acquired by the external sensor, the own vehicle state sensor, the navigation device, and the like, and transmits the driving support information to the notification device 22.

Here, the driving support ECU starts collision mitigation brake control of automatically operating a control device of the own vehicle so as to reduce damage by contact of the own vehicle and another moving body on condition that there is a moving body that may come into contact with the own vehicle within a predetermined collision mitigation brake actuation range around the own vehicle. Further, the driving support ECU starts collision avoidance control of automatically operating a steering device of the own vehicle to avoid contact of the own vehicle and another moving body on condition that there is a moving body that may come into contact with the own vehicle within a predetermined collision avoidance steering operation range around the own vehicle. In the following description, the collision mitigation brake actuation range and the collision avoidance steering operation range will be also collectively referred to as an “ADAS actuation range”.

The driving subject state sensor 23 includes various devices that acquire time-series data of information correlated with driving capability of the driver who is driving. The driving subject state sensor 23 includes, for example, an on-board camera that detects a direction of a line of sight of the driver who is driving, whether or not the driver opens his/her eyes, and the like, a seat belt sensor that is provided at a seat belt to be fastened by the driver and detects a pulse of the driver, whether or not the driver breathes, and the like, a steering sensor that is provided at a steering to be gripped by the driver and detects a skin potential of the driver, and an on-board microphone that detects whether or not there is conversation between the driver and passengers.

The on-board communication device 24 has a function of transmitting the information acquired by the driving support ECU (including the information acquired by the external sensor, the own vehicle state sensor, the navigation device, and the like, control information regarding driving support control that is being executed, and the like), the information regarding the driving subject acquired by the driving subject state sensor 23, and the like, to the coordination support device 6, and a function of receiving coordination support information transmitted from the coordination support device 6 and transmitting the received coordination support information to the notification device 22.

The notification device 22 includes various devices that notify the driver of various kinds of information through auditory sense, visual sense, haptic sense, and the like, by causing a human machine interface (hereinafter, abbreviated as an “HMI”) to operate in an aspect determined on the basis of the driving support information transmitted from the on-board driving support device 21 and the coordination support information transmitted from the coordination support device 6.

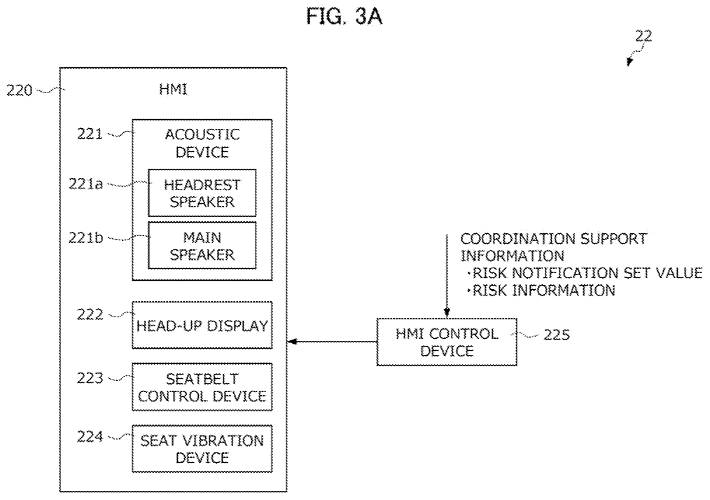

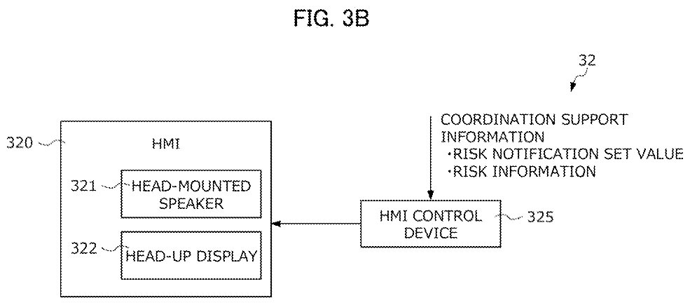

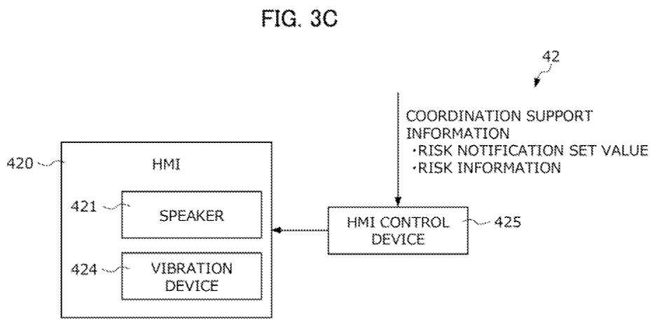

FIG. 3A is a block diagram illustrating a configuration of the notification device 22 mounted on a four-wheeled vehicle. Note that FIG. 3A illustrates, within the notification device 22, only blocks particularly regarding control based on the coordination support information transmitted from the coordination support device 6.

The notification device 22 includes an HMI 220 that operates in an aspect recognizable by the driver, and an HMI control device 225 that causes the HMI 220 to operate on the basis of the coordination support information transmitted from the coordination support device 6.

The HMI 220 includes an acoustic device 221 that operates in an aspect auditorily recognizable by the driver, a head-up display 222 that operates in an aspect visually recognizable by the driver, and a seat belt control device 223 and a seat vibration device 224 that operates in an aspect haptically recognizable by the driver.

The acoustic device 221 includes a headrest speaker 221a that is provided at a headrest of a driver's seat to be seated by the driver and capable of emitting binaural sound having directivity, and a main speaker 221b that is provided in the vicinity of the driver's seat and a passenger's seat. The headrest speaker 221a and the main speaker 221b emit sound in accordance with a command from the HMI control device 225.

The head-up display 222 displays an image in accordance with a command from the HMI control device 225 within a field of view (for example, a windshield) of the driver who is driving. The seat belt control device 223 changes tension of the seat belt to be fastened by the driver in accordance with a command from the HMI control device 225. The seat vibration device 224 vibrates the seat to be seated by the driver at an amplitude and/or a frequency in accordance with a command from the HMI control device 225.

The HMI control device 225 makes a risk notification by causing the HMI 220 to operate in the determined aspect to cause the driver to recognize a risk that comes near to the driver. As will be described later, the coordination support information transmitted from the coordination support device 6 to the four-wheeled vehicle 2 includes information regarding a risk notification set value for setting ON/OFF of the risk notification and a type of a notification mode which will be described later, to be set by the HMI control device 225, information regarding a risk that comes near to the driver (hereinafter, also referred to as “risk information”), and the like.

The HMI control device 225 can make a risk notification in a plurality of notification modes in which at least one of a device to be caused to operate among those of the HMI 220 or an operation aspect is different. More specifically, the HMI control device 225 can make a risk notification in at least one of a glimpse notification mode intended to cause the driver to recognize existence of a potential risk, an analogue notification mode intended to cause the driver to recognize existence of a visible risk and/or a level of the risk, or a prediction support notification mode intended to notify the driver of information useful for avoiding a predicted risk.

Thus, as the risk notification set value to be input to the HMI control device 225, one of “0” for setting OFF of risk notification, “1” for setting ON of risk notification in the glimpse notification mode, “2” for setting ON of risk notification in the analogue notification mode, “3” for setting ON of risk notification in the prediction support notification mode, “4” for setting ON of risk notification in the glimpse notification mode and the prediction support notification mode, and “5” for setting ON of risk notification in the analogue notification mode and the prediction support notification mode is set.

In a case where the risk notification set value is “0”, the HMI control device 225 sets OFF of risk notification. In other words, in a case where the risk notification set value is “0”, the HMI control device 225 does not cause the HMI 220 to operate.

In a case where the risk notification set value is “1”, the HMI control device 225 sets the glimpse notification mode as the notification mode and turns ON risk notification in the set notification mode.

In a case where the risk notification set value is “2”, the HMI control device 225 sets the analogue notification mode as the notification mode and turns ON risk notification in the set notification mode.

In a case where the risk notification set value is “3”, the HMI control device 225 sets the prediction support notification mode as the notification mode and turns ON risk notification in the set notification mode.

In a case where the risk notification set value is “4”, the HMI control device 225 sets the glimpse notification mode and the prediction support notification mode as the notification modes and turns ON risk notification in these set notification modes.

Further, in a case where the risk notification set value is “5”, the HMI control device 225 sets the analogue notification mode and the prediction support notification mode as the notification modes and turns ON risk notification in the set notification modes.

Here, in a case where the prediction support notification mode is set as the notification mode, the HMI control device 225 generates risk avoidance support information useful for avoiding a risk that comes near to the driver on the basis of the risk information transmitted from the coordination support device 6 and causes the acoustic device 221 and the head-up display 222 of the HMI 220 to operate in such an aspect that enables the driver to auditorily and visually recognize the risk avoidance support information. Here, the risk avoidance support information includes information regarding a position of a traffic participant which may come into contact with the own vehicle (hereinafter, also referred to as a “risk target”), information regarding a point at which the own vehicle may come into contact with the risk target (hereinafter, also referred to as a “risk occurrence point”), and information including content that evokes attention of the driver to the risk target.

More specifically, in a case where there is a motorcycle driven by an unsound rider ahead of the four-wheeled vehicle driven by the driver, the HMI control device 225 emits a message having content of “Be careful of dangerous right-turn of the motorcycle” by the acoustic device 221 or displays the message on the head-up display 222 as the risk avoidance support information for avoiding contact with the motorcycle.

Further, in this event, the HMI control device 225 may display an image of an arrow indicating a current position or a predicted position of the motorcycle on the head-up display 222 as the risk avoidance support information for avoiding contact with the motorcycle.

Still further, in a case where the glimpse notification mode is set as the notification mode, the HMI control device 225 causes the driver to naturally recognize existence of a risk target extracted from the risk information transmitted from the coordination support device 6 by causing the HMI 220 to operate in an aspect that does not make the driver feel cumbersomeness. In such a glimpse notification mode, in order to cause the driver to naturally recognize existence of a risk target without making the driver feel cumbersomeness, the HMI control device 225 preferably causes the headrest speaker 221a that particularly appeals to auditory sense of the driver among the plurality of devices included in the HMI 220. More specifically, in a case where the glimpse notification mode is set as the notification mode, the HMI control device 225 naturally brings the line of sight of the driver to a position of the risk target or a risk occurrence point by causing the headrest speaker 221a to emit a familiar sound effect with binaural sound having directivity directed to the position of the risk target or the risk occurrence point at small volume.

Further, in a case where the analogue notification mode is set as the notification mode, the HMI control device 225 causes the driver to strongly recognize existence of the risk target extracted from the risk information transmitted from the coordination support device 6 and a level of the risk by the risk target by causing the HMI 220 to operate in an aspect different from the glimpse notification mode described above. In this manner, in the analogue notification mode, to cause the driver to strongly recognize existence of the risk target, the HMI control device 225 causes the HMI 220 to operate in an aspect with higher notification strength than notification strength of the aspect set in the glimpse notification mode. Here, the notification strength refers to strength of attracting concern and attention of the driver. More specifically, in a case where the analogue notification mode is set as the notification mode, the HMI control device 225 causes the headrest speaker 221a and the main speaker 221b to emit buzzer sound or pulse sound at larger volume than the volume of the sound effect emitted in the glimpse notification mode. The buzzer sound and the pulse sound are unfamiliar high-volume sound for the driver compared to the sound effect emitted in the glimpse notification mode, and thus, the notification strength is higher than the notification strength of the sound effect emitted in the glimpse notification mode.

Note that while in the present embodiment, a case will be described where the HMI control device 225 causes the acoustic device 221 to operate in a case where the analogue notification mode is set as the notification mode, the present invention is not limited to this. In a case where the analogue notification mode is set as the notification mode, the HMI control device 225 may cause the seat belt control device 223 to operate to change tension of the seat belt or cause the seat vibration device 224 to operate to vibrate the seat instead of causing the acoustic device 221 to operate. In this manner, the seat belt control device 223 and the seat vibration device 224 operate in an aspect that appeals to haptic sense of the driver, and thus, the notification strength is higher than the notification strength of the sound effect emitted in the glimpse notification mode. Further, in a case where the analogue notification mode is set as the notification mode, the HMI control device 225 may cause the acoustic device 221, the seat belt control device 223 and the seat vibration device 224 to operate in combination.

Further, as described above, in the analogue notification mode, to cause the driver to strongly recognize a level of the risk by the risk target in addition to existence of the risk target, the HMT control device 225 preferably changes the notification strength in accordance with the level of the risk by the risk target (for example, a collision predicted period for the risk target) extracted from the risk information transmitted from the coordination support device 6. Specifically, the HMI control device 225 may increase the notification strength by increasing a volume of the buzzer sound, increasing a volume of the pulse sound or shortening an interval of the pulse sound as the level of the risk becomes higher (that is, as the collision predicted period becomes shorter). In a case where the seat belt control device 223 is caused to operate as described above, the HMI control device 225 may increase the notification strength by increasing tension of the seat belt as the level of the risk becomes higher. Further, in a case where the seat vibration device 224 is caused to operate as described above, the HMI control device 225 may increase the notification strength by increasing an amplitude of vibration of the seat as the level of the risk becomes higher.

Further, in a case where the notification strength is changed in accordance with the level of the risk in this manner, the HMI control device 225 preferably causes the HMI 220 to operate so that the notification strength becomes maximum at a time point at which execution of the collision mitigation brake control and the collision avoidance steering control is started by the driving support ECU described above, in other words, at a time point at which the risk target enters the ADAS actuation range of the own vehicle.

Returning to FIG. 2, the mobile information processing terminal 25 includes, for example, a wearable terminal to be worn by the driver of the four-wheeled vehicle 2, a smartphone possessed by the driver, and the like. The wearable terminal has a function of measuring biological information of the driver such as a heart rate, a blood pressure and a blood oxygen level and transmitting the measurement data of the biological information to the coordination support device 6 and a function of receiving the coordination support information transmitted from the coordination support device 6 and notifying the driver of a message in accordance with the coordination support information with an image, speech, warning sound, vibration, and the like. Further, the smartphone has a function of transmitting information regarding the driver such as position information, travel acceleration and schedule information of the driver to the coordination support device 6 and a function of receiving the coordination support information transmitted from the coordination support device 6 and notifying the driver of a message in accordance with the coordination support information with an image, speech, warning sound, melody, vibration, and the like.

The on-board devices 30 mounted on the motorcycles 3 in the target traffic area 9 include, for example, an on-board driving support device 31 that supports driving by a rider, a notification device 32 that notifies the rider of various kinds of information, a rider state sensor 33 that detects a state of the rider who is driving, an on-board communication device 34 that performs wireless communication between the own vehicle, and the coordination support device 6 and other vehicles near the own vehicle, a mobile information processing terminal 35 possessed or worn by the rider, and the like.

The on-board driving support device 31 includes an external sensor, an own vehicle state sensor, a navigation device, a driving support ECU, and the like. The external sensor includes an exterior camera that captures an image around the own vehicle, a plurality of on-board external sensors mounted on the own vehicle such as a radar and a LIDAR that detects a target outside the vehicle by using an electromagnetic wave, and an outside recognition device that acquires information regarding a state around the own vehicle by performing fusion processing on detection results by the on-board exterior sensors. The own vehicle state sensor includes sensors that acquire information regarding a traveling state of the own vehicle such as a vehicle speed sensor and a five-axis or six-axis inertial measurement device. The navigation device includes, for example, a GNSS receiver that specifies a current position on the basis of a signal received from a GNSS satellite, a storage device that stores map information, and the like.

The driving support ECU executes driving support control such as lane keeping control, lane departure prevention control, lane change control, preceding vehicle following control, erroneous start prevention control and collision mitigation brake control on the basis of the information acquired by the external sensor, the own vehicle state sensor, the navigation device, and the like. Further, the driving support ECU generates driving support information for supporting safe driving by the rider on the basis of the information acquired by the external sensor, the own vehicle state sensor, the navigation device, and the like, and transmits the driving support information to the notification device 32.

Here, the driving support ECU starts collision mitigation brake control of automatically operating a brake device of the own vehicle to reduce damage by contact of the own vehicle and another moving body on condition that there is a moving body that may come into contact with the own vehicle within a predetermined collision mitigation brake actuation range (hereinafter, also referred to as an “ADAS actuation range” which is also used for a term defined for the four-wheeled vehicle 2) around the own vehicle.

The rider state sensor 33 includes various devices that acquire information correlated with driving capability of the rider who is driving. The rider state sensor 33 includes, for example, a seat sensor that is provided at a seat to be seated by the rider and detects a pulse, whether or not the rider breathes, and the like, a helmet sensor that is provided at a helmet to be worn by the rider and detects a pulse of the rider, whether or not the rider breathes, a skin potential, and the like.

The on-board communication device 34 has a function of transmitting the information acquired by the driving support ECU (including the information acquired by the external sensor, the own vehicle state sensor, the navigation device, and the like, and control information regarding driving support control that is being executed), information regarding the rider acquired by the rider state sensor 33, and the like, to the coordination support device 6 and a function of receiving the coordination support information transmitted from the coordination support device 6 and transmitting the received coordination support information to the notification device 32.

The notification device 32 includes various devices that notifies the rider of various kinds of information through auditory sense, visual sense, haptic sense, and the like, by causing the HMI to operate in an aspect determined on the basis of the driving support information transmitted from the on-board driving support device 21 and the coordination support information transmitted from the coordination support device 6.

FIG. 3B is a block diagram illustrating a configuration of the notification device 32 mounted on the motorcycle. Note that FIG. 3B illustrates, within the notification device 32, only blocks particularly regarding control based on the coordination support information transmitted from the coordination support device 6.

The notification device 32 includes an HMI 320 that operates in an aspect recognizable by the rider, and an HMI control device 325 that causes the HMI 320 to operate on the basis of the coordination support information transmitted from the coordination support device 6.

The HMI 320 includes a head-mounted speaker 321 that operates in an aspect auditorily recognizable by the rider, and a head-up display 322 that operates in an aspect visually recognizable by the rider.

The head-mounted speaker 321 is provided at a helmet to be worn by the rider and is capable of emitting binaural sound having directivity. The head-mounted speaker 321 emits sound in accordance with a command from the HMI control device 325.

The head-up display 322 displays an image in accordance with a command from the HMI control device 325 within a field of view (for example, a shield of the helmet) of the rider who is driving.

The HMI control device 325 makes a risk notification that causes the HMI 320 to operate in an aspect set for causing the rider to recognize existence of a risk that comes near to the rider. As will be described later, the coordination support information transmitted from the coordination support device 6 to the motorcycle 3 includes information regarding a risk notification set value for setting ON/OFF of risk notification and a type of the notification mode, to be set by the HMT control device 325, risk information regarding a risk that comes near to the rider.

The HMI control device 325 can make a risk notification in a plurality of notification modes in which at least one of a device to be caused to operate among those of the HMI 320 or an operation aspect is different. More specifically, the HMI control device 325 can make a risk notification in at least one of a glimpse notification mode intended to cause the rider to recognize existence of a potential risk, an analogue notification mode intended to cause the rider to recognize existence of a visible risk and/or a level of the risk, or a prediction support notification mode intended to notify the rider of information useful for avoiding a predicted risk. Thus, as the risk notification set value to be input to the HMT control device 325, one of “0” for setting OFF of risk notification, “1” for setting ON of risk notification in the glimpse notification mode, “2” for setting ON of risk notification in the analogue notification mode, “3” for setting ON of risk notification in the prediction support notification mode, “4” for setting ON of risk notification in the glimpse notification mode and the prediction support notification mode, and “5” for setting ON of risk notification in the analogue notification mode and the prediction support notification mode is set.

In a case where the risk notification set value is “0”, the HMI control device 325 sets OFF of risk notification. In other words, in a case where the risk notification set value is “0”, the HMI control device 325 does not cause the HMI 320 to operate.

In a case where the risk notification set value is “1”, the HMI control device 325 sets the glimpse notification mode as the notification mode and turns ON risk notification in the set notification mode.

In a case where the risk notification set value is “2”, the HMI control device 325 sets the analogue notification mode as the notification mode and turns ON risk notification in the set notification mode.

In a case where the risk notification set value is “3”, the HMI control device 325 sets the prediction support notification mode as the notification mode and turns ON risk notification in the set notification mode.

In a case where the risk notification set value is “4”, the HMI control device 325 sets the glimpse notification mode and the prediction support notification mode as the notification modes and turns ON risk notification in the set notification modes.

In a case where the risk notification set value is “5”, the HMI control device 325 sets the analogue notification mode and the prediction support notification mode as the notification modes and turns ON risk notification in the set notification modes.

Here, in a case where the prediction support notification mode is set as the notification mode, the HMI control device 325 generates risk avoidance support information useful for avoiding a risk that comes near to the rider on the basis of the risk information transmitted from the coordination support device 6 and causes the head-mounted speaker 321 and the head-up display 322 of the HMI 320 to operate in such an aspect that enables the rider to visually and auditorily recognize the risk avoidance support information. Here, the risk avoidance support information includes information regarding a position of a risk target that may come into contact with the own vehicle, information regarding a risk occurrence point and information including content that evokes attention of the rider to the risk target.

More specifically, in a case where there is a four-wheeled vehicle driven by an unsound driver ahead of the motorcycle driven by the rider, the HMI control device 325 causes the head-mounted speaker 321 to emit a message indicating content of “Be careful of dangerous right-turn of the four-wheeled vehicle” or causes the head-up display 322 to display the message as the risk avoidance support information for avoiding contact with the four-wheeled vehicle. Further, in this event, the HMI control device 325 may cause the head-up display 322 to display an image of an arrow indicating a current position or a predicted position of the four-wheeled vehicle as the risk avoidance support information for avoiding contact with the four-wheeled vehicle.

Further, in a case where the glimpse notification mode is set as the notification mode, the HMI control device 325 causes the rider to naturally recognize existence of a risk target extracted from the risk information transmitted from the coordination support device 6 by causing the HMI 320 to operate in an aspect that does not make the rider feel cumbersomeness. In such a glimpse notification mode, to cause the rider to naturally recognize existence of the risk target without making the rider feel cumbersomeness, the HMI control device 325 preferably causes particularly the head-mounted speaker 321 that appeals to auditory sense of the rider to operate among the plurality of devices included in the HMI 320. More specifically, in a case where the glimpse notification mode is set as the notification mode, the HMI control device 325 naturally brings the line of sight of the rider to a position of the risk target or the risk occurrence point by causing the head-mounted speaker 321 to emit low-volume familiar sound effect with binaural sound having directivity directed to the position of the risk target or the risk occurrence point.

In a case where the analogue notification mode is set as the notification mode, the HMI control device 325 causes the rider to strongly recognize existence of the risk target extracted from the risk information transmitted from the coordination support device 6 and a level of the risk by the risk target by causing the HMI 320 to operate in an aspect different from the glimpse notification mode described above.

In this manner, in the analogue notification mode, to cause the rider to strongly recognize existence of the risk target, the HMI control device 325 causes the HMI 320 to operate in an aspect with notification strength higher than notification strength in an aspect set in the glimpse notification mode.

More specifically, in a case where the analogue notification mode is set as the notification mode, the HMI control device 325 causes the head-mounted speaker 321 to emit buzzer sound or pulse sound at larger volume than a volume of the sound effect emitted in the glimpse notification mode. The buzzer sound and the pulse sound are unfamiliar high-volume sound for the rider compared to the sound effect emitted in the glimpse notification mode, and thus, the notification strength is higher than the notification strength of the sound effect emitted in the glimpse notification mode.

Further, as described above, to cause the rider to strongly recognize the level of the risk by the risk target in addition to existence of the risk target, the HMI control device 325 preferably changes the notification strength in accordance with the level of the risk by the risk target (for example, a collision predicted period for the risk target) extracted from the risk information transmitted from the coordination support device 6. Specifically, the HMI control device 325 may increase the notification strength by increasing a volume of the buzzer sound, increasing a volume of the pulse sound or shortening an interval of the pulse sound as the level of the risk becomes higher (that is, as the collision predicted period becomes shorter).

Further, in a case where the notification strength is changed in accordance with the level of the risk in this manner, the HMI control device 325 preferably causes the HMI 320 to operate so that the notification strength becomes maximum at a time point at which execution of collision mitigation brake control is started by the driving support ECU described above, in other words, at a time point at which the risk target enters the ADAS actuation range.

Returning to FIG. 2, the mobile information processing terminal 40 possessed or worn by the pedestrian 4 in the target traffic area 9 includes, for example, a wearable terminal to be worn by the pedestrian 4, a smartphone possessed by the pedestrian 4, and the like. The wearable terminal has a function of measuring biological information of the pedestrian 4 such as a heart rate, a blood pressure and a blood oxygen level and transmitting the measurement data of the biological information to the coordination support device 6 and receiving the coordination support information transmitted from the coordination support device 6. Further, the smartphone has a function of transmitting pedestrian information regarding the pedestrian 4 such as position information, travel acceleration, schedule information, and the like, of the pedestrian 4 to the coordination support device 6 and receiving the coordination support information transmitted from the coordination support device 6.

Further, the mobile information processing terminal 40 includes a notification device 42 that notifies the pedestrian of various kinds of information through auditory sense, visual sense, haptic sense, and the like, of the pedestrian by causing the HMT to operate in an aspect determined on the basis of the received coordination support information.

FIG. 3C is a block diagram illustrating a configuration of the notification device 42 mounted on the mobile information processing terminal 40. Note that FIG. 3C illustrates, within the notification device 42, only blocks particularly regarding control based on the coordination support information transmitted from the coordination support device 6.

The notification device 42 includes an HMI 420 that operates in an aspect recognizable by the pedestrian, and an HMI control device 425 that causes the HMI. 420 to operate on the basis of the coordination support information transmitted from the coordination support device 6.

The HMI 420 includes a speaker 421 that operates in an aspect auditorily recognizable by the pedestrian, and a vibration device 424 that operates in an aspect haptically recognizable by the pedestrian.

The speaker 421 emits sound in accordance with a command from the HMI control device 425. The vibration device 424 vibrates a body of the mobile information processing terminal 40 at an amplitude and/or a frequency in an aspect in accordance with a command from the HMI control device 425.

As will be described later, the coordination support information transmitted from the coordination support device 6 to the mobile information processing terminal 40 possessed by the pedestrian includes information regarding a risk notification set value for setting ON/OFF of risk notification and a type of the notification mode to be set by the HMI control device 425, risk information regarding a risk that comes near to the pedestrian, and the like.

The HMI control device 425 can make a risk notification in a plurality of notification modes in which at least one of a device to be caused to operate among those of the HMI 420 or an operation aspect is different. More specifically, the HMI control device 425 can make a risk notification in at least one of a glimpse notification mode intended to cause the pedestrian to recognize existence of a potential risk or an analogue notification mode intended to cause the pedestrian to recognize existence of a visible risk and/or a level of the risk. Thus, as the risk notification set value to be input to the HMI control device 425, one of “0” for setting OFF of risk notification by the HMI control device 425, “1” for setting ON of the risk notification by the HMI control device 425 and setting the glimpse notification mode as the notification mode and “²” for setting ON of risk notification by the HMI control device 425 and setting the analogue notification mode as the notification mode is set.

In a case where the risk notification set value is “0”, the HMI control device 425 sets OFF of risk notification. In other words, in a case where the risk notification set value is “0”, the HMI control device 425 does not cause the HMI 420 to operate.

In a case where the risk notification set value is “1”, the HMI control device 425 sets the glimpse notification mode as the notification mode and turns ON risk notification in the set notification mode.

In a case where the risk notification set value is “2”, the HMI control device 425 sets the analogue notification mode as the notification mode and turns ON risk notification in the set notification mode.

Here, the HMI control device 425 causes the pedestrian to naturally recognize existence of a risk target extracted from the risk information transmitted from the coordination support device 6 by causing the HMI 420 to operate in an aspect that does not make the pedestrian feel cumbersomeness. More specifically, in a case where the glimpse notification mode is set as the notification mode, the HMI control device 425 vibrates the body of the mobile information processing terminal 40 at a predetermined amplitude and frequency by causing the vibration device 424 to operate.

Further, in a case where the analogue notification mode is set as the notification mode, the HMI control device 425 causes the pedestrian to strongly recognize existence of a risk target extracted from the risk information transmitted from the coordination support device 6 and a level of a risk by the risk target by causing the HMI 420 to operate in an aspect different from the glimpse notification mode described above. In this manner, in the analogue notification mode, to cause the pedestrian to strongly recognize existence of the risk target, the HMI control device 425 causes the HMI 420 to operate in an aspect with notification strength higher than notification strength in an aspect set in the glimpse notification mode. More specifically, in a case where the analogue notification mode is set as the notification mode, the HMI control device 425 causes the speaker 421 to emit buzzer sound, pulse sound, a message indicating that there is a risk, or the like.

Further, as described above, in the analogue notification mode, to cause the pedestrian to strongly recognize a level of the risk by the risk target in addition to existence of the risk target, the HMI control device 425 preferably changes the notification strength in accordance with the level of the risk by the risk target (for example, a collision predicted period for the risk target) extracted from the risk information transmitted from the coordination support device 6.

Specifically, the HMI control device 425 may increase the notification strength by increasing a volume of the buzzer sound, increasing a volume of the pulse sound, shortening an interval of the pulse sound, increasing a volume of the message or changing content of the message as the level of the risk becomes higher (that is, as the collision predicted period becomes shorter).

Returning to FIG. 2, the infrastructure camera 56 captures images of traffic infrastructure equipment including a road, an intersection and a pavement in a target traffic area and moving bodies and pedestrians that move on the road, the intersection, the pavement, and the like, and transmits the obtained image information to the coordination support device 6.

The traffic light control device 55 controls the traffic lights and transmits traffic light state information regarding current lighting color of the traffic lights provided in the target traffic area, a timing at which the lighting color is switched, and the like, to the coordination support device 6.

The coordination support device 6 is a computer that supports safe and smooth traffic of the traffic participants in the target traffic area by generating coordination support information for encouraging communication between the traffic participants and recognition of a surrounding traffic environment for each traffic participant to be supported on the basis of the information acquired from a plurality of area terminals existing in the target traffic area as described above and notifying each traffic participant. Note that in the present embodiment, traffic participants including means for receiving the coordination support information generated at the coordination support device 6 and causing the HMI to operate in an aspect set on the basis of the received coordination support information (for example, the on-board devices 20 and 30, the mobile information processing terminal 40 and the notification devices 22, 32 and 42) among the plurality of traffic participants existing in the target traffic area are set as targets to be supported by the coordination support device 6.

The coordination support device 6 includes a target traffic area recognizer 60 that recognizes persons and moving bodies in the target traffic area as individual traffic participants, a driving subject information acquirer 61 that acquires driving subject state information correlated with driving capabilities of driving subjects of the moving bodies recognized as the traffic participants by the target traffic area recognizer 60, a predictor 62 that predicts futures of a plurality of traffic participants in the target traffic area, a coordination support information notifier 65 that transmits coordination support information generated for each of the individual traffic participants recognized as support targets by the target traffic area recognizer 60, a traffic environment database 67 in which information regarding a traffic environment of the target traffic area is accumulated, and a driving history database 68 in which information regarding past driving history by the driving subjects registered in advance is accumulated.

In the traffic environment database 67, information regarding traffic environments of the traffic participants in the target traffic area such as map information of the target traffic area registered in advance (for example, a width of the road, the number of lanes, speed limit, a width of the pavement, whether or not there is a guardrail between the road and the pavement, a position of a crosswalk) and risk area information regarding a high risk area with a particularly high risk in the target traffic area, is stored. In the following description, the information stored in the traffic environment database 67 will be also referred to as registered traffic environment information.

In the driving history database 68, information regarding past driving history of the driving subjects registered in advance is stored in association with registration numbers of moving bodies possessed by the driving subjects. Thus, if the registration numbers of the recognized moving bodies can be specified by the target traffic area recognizer 60 which will be described later, the past driving history of the driving subjects of the recognized moving bodies can be acquired by searching the driving history database 68 on the basis of the registration numbers. In the following description, the information stored in the driving history database 68 will also be referred to as registered driving history information.

The target traffic area recognizer 60 recognizes traffic participants that are persons or moving bodies in the target traffic area and recognition targets including traffic environments of the respective traffic participants in the target traffic area on the basis of the information transmitted from the above-described area terminal (the on-board devices 20 and 30, the mobile information processing terminal 40, the infrastructure camera 56 and the traffic light control device 55) in the target traffic area and the registered traffic environment information read from the traffic environment database 67 and acquires recognition information regarding the recognition targets.

Here, the information transmitted from the on-board driving support device 21 and the on-board communication device 24 included in the on-board devices 20 to the target traffic area recognizer 60 and the information transmitted from the on-board driving support device 31 and the on-board communication device 34 included in the on-board devices 30 to the target traffic area recognizer 60 include information regarding traffic participants around the own vehicle and a state regarding the traffic environment acquired by the external sensor, information regarding a state of the own vehicle as one traffic participant acquired by the own vehicle state sensor, the navigation device and the like, and the like. Further, the information transmitted from the mobile information processing terminal 40 to the target traffic area recognizer 60 includes information regarding a state of a pedestrian as one traffic participant, such as a position and travel acceleration. Still further, the image information transmitted from the infrastructure camera 56 to the target traffic area recognizer 60 includes information regarding the respective traffic participants and traffic environments of the traffic participants, such as appearance of the traffic infrastructure equipment such as the road, the intersection and the pavement, and appearance of traffic participants moving in the target traffic area. Further, the traffic light state information transmitted from the traffic light control device 55 to the target traffic area recognizer 60 includes information regarding traffic environments of the respective traffic participants such as current lighting color of the traffic lights and a timing for switching the lighting color. Further, the registered traffic environment information to be read by the target traffic area recognizer 60 from the traffic environment database 67 includes information regarding traffic environments of the respective traffic participants such as map information, the risk area information, and the like, of the target traffic area.

Thus, the target traffic area recognizer 60 can acquire recognition information of each traffic participant (hereinafter, also referred to as “traffic participant recognition information”) such as a position of each traffic participant in the target traffic area, a moving vector (that is, a vector extending along a moving direction and having a length proportional to moving speed), travel acceleration, a vehicle type of the moving body, a vehicle rank, registration number of the moving body, the number of people of the pedestrian and an age group of the pedestrian on the basis of the information transmitted from the area terminals. Further, the target traffic area recognizer 60 can acquire recognition information of the traffic environment (hereinafter, also referred to as “traffic environment recognition information”) of each traffic participant in the target traffic area such as a width of the road, the number of lanes, speed limit, a width of the pavement, whether or not there is a guardrail between the road and the pavement, lighting color of the traffic light, a switching timing of the lighting color, and the risk area information on the basis of the information transmitted from the area terminals.

The target traffic area recognizer 60 transmits the traffic participant recognition information and the traffic environment recognition information acquired as described above to the driving subject information acquirer 61, the predictor 62, the coordination support information notifier 65, and the like.

The driving subject information acquirer 61 acquires driving subject state information and driving subject characteristic information correlated with current driving capabilities of the driving subjects of the moving bodies recognized as the traffic participants by the target traffic area recognizer 60 on the basis of the information transmitted from the above-described area terminals (particularly, the on-board devices 20 and 30) in the target traffic area and the registered driving history information read from the driving history database 68.

More specifically, in a case where the driving subject of the four-wheeled vehicle recognized as the traffic participant by the target traffic area recognizer 60 is a person, the driving subject information acquirer 61 acquires the information transmitted from the on-board devices 20 mounted on the four-wheeled vehicle as driving subject state information of the driver. Further, in a case where the driving subject of the motorcycle recognized as the traffic participant by the target traffic area recognizer 60 is a person, the driving subject information acquirer 61 acquires the information transmitted from the on-board devices 30 mounted on the motorcycle as driving subject state information of the rider.

Here, the information to be transmitted from the driving subject state sensor 23 and the on-board communication device 24 included in the on-board devices 20 to the driving subject information acquirer 61 includes time-series data regarding appearance information such as a direction of a line of sight of the driver who is driving and whether or not the driver opens his/her eyes, biological information such as a pulse, whether or not the driver breathes, and a skin potential, speech information such as whether or not there is conversation, and the like, which is correlated with driving capability of the driver who is driving. Further, the information to be transmitted from the rider state sensor 33 and the on-board communication device 34 included in the on-board devices 30 to the driving subject information acquirer 61 includes time-series data regarding biological information such as a pulse of the rider, whether or not the rider breathes and a skin potential, which is correlated with driving capability of the rider who is driving. Further, the information to be transmitted from the mobile information processing terminals 25 and 35 included in the on-board devices 20 and 30 to the driving subject information acquirer 61 includes personal schedule information of the driver and the rider. In a case where the driver and the rider drive the moving bodies, for example, under tight schedule, there is a case where the driver and the rider may feel pressed, and driving capabilities may degrade. Thus, it can be said that the personal schedule information of the driver and the rider is information correlated with the driving capabilities of the driver and the rider.

The driving subject information acquirer 61 acquires driving subject characteristic information regarding characteristics (such as, for example, too many times of sudden lane change and too many times of sudden acceleration and deceleration) regarding driving of the driving subject correlated with current driving capability of the driving body who is driving by using both or one of the driving subject state information for the driving subject acquired through the following procedure and the registered driving history information read from the driving history database 68.

The driving subject information acquirer 61 transmits the driving subject state information and the driving subject characteristic information of the driving subject acquired as described above to the predictor 62, the coordination support information notifier 65 and the like.

The predictor 62 extracts part of the traffic area in the target traffic area as a monitoring area and predicts future risks among a plurality of traffic participants in the monitoring area on the basis of the traffic participant recognition information and the traffic environment recognition information acquired by the target traffic area recognizer 60 and the driving subject state information and the driving subject characteristic information acquired by the driving subject information acquirer 61.

Here, the target traffic area is a traffic area of a relatively broad range determined, for example, in municipal units. In contrast, the monitoring area is a traffic area such as, for example, an area near an intersection and a specific facility, through which a four-wheeled vehicle can pass in an approximately few tens of seconds in a case where the four-wheeled vehicle travels at legal speed. In other words, the monitoring area is narrower than the target traffic area, but is broader than the ADAS actuation range of the driving support ECU mounted on each moving body.

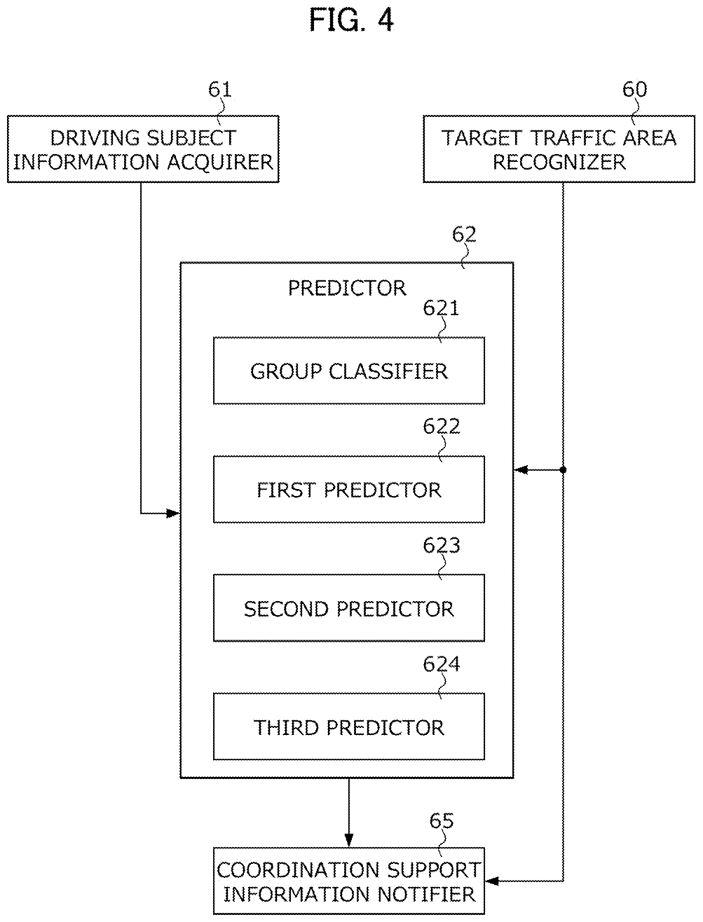

FIG. 4 is a functional block diagram illustrating a specific configuration of the predictor 62. The predictor 62, which includes a group classifier 621, a first predictor 622, a second predictor 623 and a third predictor 624, predicts futures of a plurality of prediction targets in the monitoring area by using these.

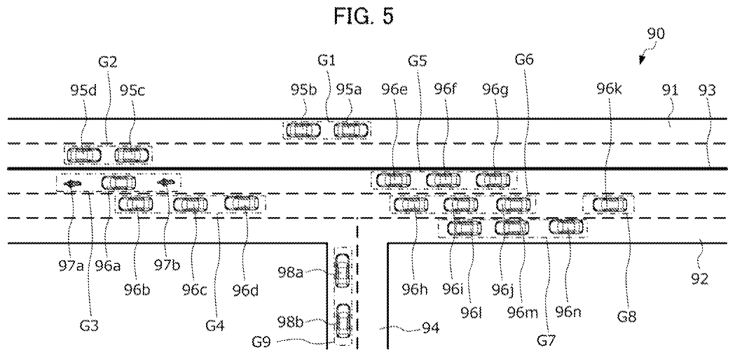

The group classifier 621 divides the plurality of traffic participants existing within the monitoring area into a plurality of moving groups on the basis of the traffic participant recognition information and the traffic environment recognition information and acquires moving group information for each moving group. Here, specific procedure for classifying the plurality of traffic participants into a plurality of moving groups at the group classifier 621 will be described with reference to FIG. 5.

FIG. 5 is a view illustrating an example of a monitoring area 90. The monitoring area 90 illustrated in FIG. 5 includes a two-lane road 91, and a three-lane road 92 which is an opposite lane of the road 91, a center median 93 provided between the roads 91 and 92, and a two-lane service road 94 connected to the road 92. Note that FIG. 5 illustrates a case where a total of four four-wheeled vehicles 95a to 95d travel on the road 91, a total of 14 four-wheeled vehicles 96a to 96n and a total of two motorcycles 97a to 97b travel on the road 92, and a total of two four-wheeled vehicles 98a to 98b travel on the service road 94. Note that while in the following description, an example of a traffic area in which so-called left-side driving is stipulated (that is, a traffic area in which a vehicle must travel on the left side from the center of the road) will be described, the present invention is not limited to this. In other words, the present invention can also be applied to a traffic area in which so-called right-side driving is stipulated (that is, a traffic area in which a vehicle must travel on a right side from the center of the road).

The group classifier 621 acquires traffic participant recognition information of the four-wheeled vehicles 95a to 95d, 96a to 96n and 98a to 98b and the motorcycles 97a to 97b recognized as the traffic participants existing in the monitoring area 90 by the target traffic area recognizer 60 and the traffic environment recognition information of the monitoring area 90 and divides the plurality of traffic participants into moving groups G1, G2, G3, G4, G5, G6, G7, G8 and G9 which are less than a total of the traffic participants (in the example in FIG. 5, 22) on the basis of the recognition information. Here, each moving group includes one or a plurality of traffic participants that move while forming one lump. Thus, the group classifier 621 classifies one or more traffic participants existing within a predetermined range and having substantially the same moving vector into one moving group.

Thus, in the example illustrated in FIG. 5, 22 traffic participants existing within the monitoring area 90 are divided into nine moving groups G1 to G9 of the moving group G1 including two four-wheeled vehicles 95a to 95b, the moving group G2 including two four-wheeled vehicles 95c to 95d, the moving group G3 including one four-wheeled vehicle 96a and two motorcycles 97a to 97b, the moving group G4 including three four-wheeled vehicles 96b to 96d, the moving group G5 including three four-wheeled vehicles 96e to 96g, the moving group G6 including three four-wheeled vehicles 96h to 96j, the moving group G7 including three four-wheeled vehicles 96l to 96n, the moving group G8 including one four-wheeled vehicle 96k and the moving group G9 including two four-wheeled vehicles 98a to 98b.

Further, the group classifier 621 divides the plurality of traffic participants into a plurality of moving groups through the above-described procedure and then acquires moving group information for each moving group. Here, the moving group information includes a position of the moving group, a shape of the moving group (that is, distribution profile of a plurality of traffic participants that constitute the moving group), a moving vector of the moving group, and the like.

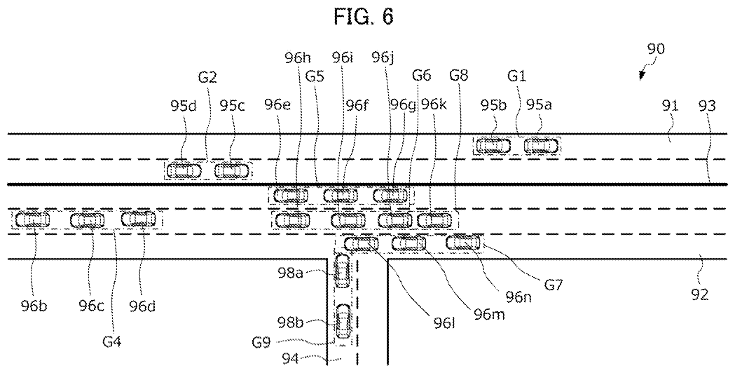

Returning to FIG. 4, the first predictor 622 predicts whether or not a collision will occur among the moving groups by estimating a position of each moving group in the future after a predetermined period on the basis of the traffic environment recognition information of the monitoring area 90 and the moving group information acquired by the group classifier 621 and specifies collision sites in the moving groups that are predicted to collide. Here, procedure for determining whether or not a collision will occur among the moving groups and specifying collision sites at the first predictor 622 will be described with reference to FIG. 6.

FIG. 6 is a view illustrating an example of a prediction result of the first predictor 622. More specifically, FIG. 6 is a view illustrating a position of each moving group in the future after a predetermined period, estimated by the first predictor 622 on the basis of the traffic environment recognition information and the moving group information.

In the example illustrated in FIG. 6, the first predictor 622 predicts that collisions will occur between the moving group G6 and the moving group G8 and between the moving group G7 and the moving group G9 a predetermined period after the state illustrated in FIG. 5. More specifically, the first predictor 622 predicts that the moving group G8 that moves at higher speed than the moving group G6 at a time point illustrated in FIG. 5 will collide with the moving group G6 existing ahead, and the moving group G9 that moves without reducing speed in the vicinity of the intersection will collide with the moving group G7 that enters the intersection.

Further, the first predictor 622 specifies collision sites in the moving groups G6, G7, G8 and G9 that are predicted to collide by using the prediction results as described above.

In the example illustrated in FIG. 6, the first predictor 622 specifies a rear end portion of the moving group G6 (that is, a portion in which the four-wheeled vehicle 96j exists), a front end portion of the moving group G8 (that is, a portion in which the four-wheeled vehicle 96k exists), a front end portion of the moving group G7 (that is, a portion in which the four-wheeled vehicle 96l exists), and a front end portion of the moving group G9 (that is, a portion in which the four-wheeled vehicle 98a exists) as the collision sites.

Returning to FIG. 4, in a case where it is predicted by the first predictor 622 that at least one set of moving groups will collide, the second predictor 623 determines two or more specific traffic participants among the plurality of traffic participants existing in the monitoring area on the basis of the collision sites specified by the first predictor 622 and predicts whether or not a collision will occur among the specific traffic participants.

More specifically, the second predictor 623 determines traffic participants existing at positions closest to the collision sites among the traffic participants constituting the moving groups that are predicted to collide by the first predictor 622 as the specific traffic participants. Thus, in the examples illustrated in FIG. 5 and FIG. 6, the second predictor 623 determines the four-wheeled vehicle 96j in the moving group G6, the four-wheeled vehicle 96k in the moving group G8, the four-wheeled vehicle 96l in the moving group G7, and the four-wheeled vehicle 98a in the moving group G9 as the specific traffic participants.

Then, the second predictor 623 acquires the traffic environment recognition information of the monitoring area, the traffic participant recognition information, the driving subject state information and the driving subject characteristic information for the determined specific traffic participants and predicts whether or not a collision will occur among the specific traffic participants in the future on the basis of the information. In other words, the second predictor 623 can take into account a state of recognition of surroundings by the drivers of the respective specific traffic participants by using the driving subject state information and the driving subject characteristic information which are not used in the first predictor 622, so that the second predictor 623 can predict whether or not a collision will occur among the specific traffic participants in the future with higher accuracy than the first predictor 622. Thus, in the examples illustrated in FIG. 5 and FIG. 6, the second predictor 623 predicts whether or not a collision will occur between the four-wheeled vehicle 96j and the four-wheeled vehicle 96k in the future and whether or not a collision will occur between the four-wheeled vehicle 96l and the four-wheeled vehicle 98a in the future on the basis of the traffic environment recognition information, the traffic participant recognition information, the driving subject state information and the driving subject characteristic information.

In a case where it is predicted by the second predictor 623 that a collision will occur in at least one set of traffic participants, the third predictor 624 predicts whether or not there is a risk posed to traffic participants existing around the specific traffic participants due to at least one of the two or more specific traffic participants taking collision avoidance action for avoiding the predicted collision. Here, the collision avoidance action includes collision mitigation braking, collision avoidance steering, and the like, to be mainly performed by the driving support ECU in addition to avoidance action (for example, sudden braking and sudden steering) to be mainly performed by the driver. Thus, in the examples illustrated in FIG. 5 and FIG. 6, in a case where it is predicted that, for example, the four-wheeled vehicle 96k is likely to perform sudden steering to the right side to avoid collision with the four-wheeled vehicle 96j, the third predictor 624 predicts that a collision risk will occur in the four-wheeled vehicle 96g. Further, in a case where it is predicted that, for example, the four-wheeled vehicle 98a is likely to actuate collision mitigation braking to avoid collision with the four-wheeled vehicle 96l, the third predictor 624 predicts that a collision risk will occur in the four-wheeled vehicle 98b that travels behind the four-wheeled vehicle 98a.

The coordination support information notifier 65 determines notification targets among the plurality of traffic participants recognized as support targets by the target traffic area recognizer 60 on the basis of the recognition information acquired by the target traffic area recognizer 60, the driving subject information acquired by the driving subject information acquirer 61 and the prediction results in the monitoring area by the predictor 62 and notifies the notification targets.

As described above, the support targets include a means (for example, the on-board devices 20 and 30, the mobile information processing terminal 40 and the notification devices 22, 32 and 42) for causing the HMI to operate in an aspect determined on the basis of the coordination support information transmitted from the coordination support device 6. Thus, the coordination support information notifier 65 makes a notification by transmitting the coordination support information generated for each notification target to each notification target and causing each HMI to operate.

First, the coordination support information notifier 65 determines a plurality of notification targets among the plurality of traffic participants existing in the monitoring area on the basis of the prediction results regarding the monitoring area by the predictor 62. More specifically, the coordination support information notifier 65 determines the specific traffic participants that are predicted to collide by the second predictor 623 as first notification targets, determines traffic participants other than the first notification targets among the traffic participants belonging to the moving groups predicted to collide by the first predictor 622 as second notification targets, and determines traffic participants other than the first and the second notification targets among the traffic participants to which it is predicted by the third predictor 624 that some kind of risk is to be posed as third notification targets. In other words, in the examples illustrated in FIG. 5 and FIG. 6, the coordination support information notifier 65 determines the four-wheeled vehicles 96j, 96k, 96l and 98a as the first notification targets, determines the four-wheeled vehicles 96h, 96i, 96m, 96n and 98b as the second notification targets, and determines the four-wheeled vehicle 96g as the third notification target.

Then, the coordination support information notifier 65 sets the risk notification set value at “2” or “5” to start risk notification in the analogue notification mode for the first notification targets. Further, the coordination support information notifier 65 sets the risk notification set value at “1” or “4” to start risk notification in the glimpse notification mode with lower notification strength than notification strength in the analogue notification mode for the second notification targets and the third notification target.

Still further, the coordination support information notifier 65 sets the risk notification set value for each notification target through the procedure described above and then transmits coordination support information including information regarding the risk notification set value, risk information regarding a risk that comes near to each notification target, and the like, to each notification target.

Note that while in the present embodiment, the coordination support information notifier 65 sets the risk notification set value so that a risk notification is made in the glimpse notification mode for the second and the third notification targets, the present invention is not limited to this. More specifically, notification strength of the notifications to be made to the second and the third notification targets may be changed in accordance with distances between the second and the third notification targets and the first notification targets. In other words, the notification strength may be made lower as a distance between the second and the third notification targets and the first notification targets becomes longer.

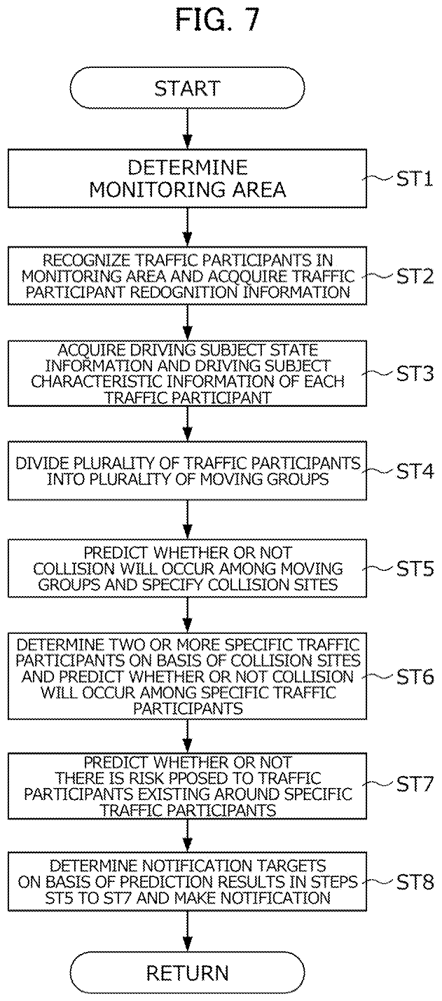

FIG. 7 is a flowchart illustrating specific procedure of traffic safety support processing of supporting safe traffic of a plurality of traffic participants in the target traffic area by the coordination support device 6. Each step indicated in the flowchart in FIG. 7 is implemented by a computer program stored in a storage medium which is not illustrated being executed by the coordination support device 6.

First, in step ST1, the coordination support device 6 determines the monitoring area among the target traffic area, and the processing transitions to step ST2. In step ST2, the coordination support device 6 recognizes traffic participants existing in the monitoring area and acquires traffic participant recognition information including a position, a moving vector and the like, of each traffic participant, and the processing transitions to step ST3. Then, in step ST3, the coordination support device 6 acquires driving subject state information and driving subject characteristic information of a plurality of traffic participants recognized in step ST2, and the processing transitions to step ST4.

Then, in step ST4, the coordination support device 6 divides the plurality of traffic participants existing in the monitoring area into a plurality of moving groups on the basis of the traffic participant recognition information acquired in step ST2 and acquires moving group information of each moving group, and the processing transitions to step ST5. In step ST5, the coordination support device 6 predicts whether or not a collision will occur among the moving groups in the future on the basis of the moving group information and specifies collision sites in the respective moving groups, and the processing transitions to step ST6.

In step ST6, in a case where it is predicted in step ST5 that a collision will occur among the moving groups, the coordination support device 6 determines two or more specific traffic participants on the basis of the collision sites. Further, in step ST6, the coordination support device 6 predicts whether or not a collision will occur among the specific traffic participants on the basis of the traffic participant recognition information, the driving subject state information and the driving subject characteristic information, and the processing transitions to step ST7.

In step ST7, in a case where it is predicted in step ST6 that a collision will occur among the specific traffic participants, the coordination support device 6 predicts whether or not there is a risk posed to traffic participants existing around the specific traffic participants due to at least one of the two or more specific traffic participants taking collision avoidance action for avoiding the predicted collision, and the processing transitions to step ST8.

In step ST8, the coordination support device 6 determines notification targets among the plurality of traffic participants in the monitoring area on the basis of the prediction results in step ST5 to step ST7 and notifies each notification target, and the processing returns to step ST1.

While one embodiment of the present invention has been described above, the present invention is not limited to this. Detailed configurations may be changed as appropriate within a scope of gist of the present invention.

### EXPLANATION OF REFERENCE NUMERALS

1 Traffic safety support system
9 Target traffic area
2 Four-wheeled vehicle (traffic participant)
20 on-board devices
3 Motorcycle (traffic participant)
30 on-board devices
4 Pedestrian (traffic participant)
40 Mobile information processing terminal
6 Coordination support device
60 Target traffic area recognizer (recognizer)
61 Driving subject information acquirer
62 Predictor
621 Group classifier (classifier)
622 First predictor
623 Second predictor
624 Third predictor
65 Coordination support information notifier (notifier)

What is claimed is:

1. A traffic safety support system comprising:
a recognizer configured to recognize traffic participants as persons or moving bodies in a target traffic area and acquire recognition information regarding each traffic participant;
a predictor configured to predict futures of a plurality of the traffic participants recognized by the recognizer on a basis of the recognition information; and
a notifier configured to determine notification targets among the plurality of traffic participants on a basis of a prediction result by the predictor and notify the notification targets,
wherein the recognizer acquires information including a position and a moving vector of each traffic participant as the recognition information, and
the predictor comprises:
a classifier configured to divide the plurality of traffic participants recognized by the recognizer into a plurality of moving groups on a basis of the recognition information and acquire moving group information including a position, a shape and a moving vector of each moving group;
a first predictor configured to predict whether or not a collision will occur among the moving groups on a basis of the moving group information and specify collision sites in the moving groups that are predicted to collide; and
a second predictor configured to, in a case where it is predicted by the first predictor that a collision will occur, determine two or more specific traffic participants among the plurality of traffic participants on a basis of the collision sites and predict whether or not a collision will occur among the specific traffic participants.

2. The traffic safety support system according to claim 1, further comprising:
a driving subject information acquirer configured to acquire state information correlated with driving capabilities of driving subjects of the moving bodies recognized as the traffic participants by the recognizer,
wherein the second predictor predicts whether or not a collision will occur among the specific traffic participants on a basis of the recognition information and the state information for the specific traffic participants.

3. The traffic safety support system according to claim 1, further comprising:
a third predictor configured to, in a case where at least one of the two or more specific traffic participants that are predicted to collide by the second predictor takes collision avoidance action, predict a risk posed to traffic participants existing around the specific traffic participants.

4. The traffic safety support system according to claim 1,
wherein the notifier
makes a first notification to the specific traffic participants as first notification targets, and
makes a second notification with lower notification strength than notification strength of the first notification to traffic participants other than the specific traffic participants among traffic participants belonging to the moving groups that are predicted to collide by the first predictor, as second notification targets.

5. The traffic safety support system according to claim 4,
wherein the notifier makes the notification strength of the second notification lower as a distance between the specific traffic participants and the second notification targets becomes longer.

6. The traffic safety support system according to claim 3,
wherein the notifier
makes a first notification to the specific traffic participants as first notification targets,
makes a second notification with lower notification strength than notification strength of the first notification to traffic participants other than the specific traffic participants among traffic participants belonging to the moving groups that are predicted to collide by the first predictor, as second notification targets, and
makes a third notification with lower notification strength than the notification strength of the first notification to traffic participants to which it is predicted by the third predictor that a risk is to be posed, as third notification targets.

7. A storage medium storing a computer program for a computer comprising:
a recognizer configured to recognize traffic participants as persons or moving bodies in a target traffic area and acquire recognition information regarding each traffic participant; and
a predictor configured to predict futures of a plurality of the traffic participants recognized by the recognizer on a basis of the recognition information,
the computer program comprising:
a recognition step of acquiring information including a position and a moving vector of each traffic participant as the recognition information;
a classification step of dividing the plurality of traffic participants recognized in the recognition step into a plurality of moving groups on a basis of the recognition information and acquiring moving group information including a position, a shape and a moving vector of each moving group;
a first prediction step of predicting whether or not a collision will occur among the moving groups on a basis of the moving group information and specifying collision sites in the moving groups that are predicted to collide;
a second prediction step of, in a case where it is predicted in the first prediction step that a collision will occur, determining two or more specific traffic participants among the plurality of traffic participants on a basis of the collision sites and predicting whether or not a collision will occur among the specific traffic participants; and
a notification step of determining notification targets among the plurality of traffic participants on a basis of prediction results in the first and the second prediction steps and notifying the notification targets.
